(19) United States
(12) Patent Application Publication
(10) Pub. No.: US 2026/0147328 A1
(43) Pub. Date: May 28, 2026

(54) TECHNOLOGIES FOR PERFORMING EFFICIENT DIAGNOSTIC OPERATIONS ON A ROBOTIC MANUFACTURING SYSTEM

(71) Applicant: MITEK HOLDINGS, INC., Wilmington, DE (US)

(72) Inventors: Xavier Ficquet, Bath (GB); Shane Byers, Hutchinson, KS (US); Shaun Dupree, Chesterfield, MO (US); Xavier Kedzierski, Saint-Lazare (CA); Okera Beckford, Wolverhampton (GB)

(21) Appl. No.: 18/959,079

(22) Filed: Nov. 25, 2024

(51) Int. Cl. G05B 19/4063; G05B 19/401

(52) U.S. Cl. CPC G05B 19/4063; G05B 19/401; G05B 2219/31433; G05B 2219/39412

(57) ABSTRACT

Technologies for performing efficient diagnostic operations on a robotic manufacturing system include circuitry configured to interface with a robotic manufacturing system that is configured to automate robotic manufacturing operations across multiple robotic manufacturing devices. The robotic manufacturing operations may be automated according to one or more recipes that define the robotic manufacturing operations in association with one or more jobs indicative of one or more building components to be manufactured. The circuitry may also be configured to perform one or more diagnostic operations associated with at least one robotic manufacturing device of the robotic manufacturing system while isolating the one or more diagnostic operations from the automated robotic manufacturing operations of the robotic manufacturing system, to prevent interference with the production of the one or more building components.

### BACKGROUND

Manufacturing systems typically include a multitude of individual machines that may operate in coordination to produce a resulting product. As a result of the complex interactions between the machines, the precise source of a defect in the product may be difficult to determine. Likewise, the complex interactions may obfuscate the effect of a change to a parameter of a machine in the system. Further, testing the operations of a given machine may be technically difficult, as some changes may result in interruption of other operations within the manufacturing system or, worse, may result in physical damage due to an unforeseen collision between machine components.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for performing diagnostic operations on a robotic manufacturing system;

FIG. 2 is a diagram of at least one embodiment of a compute device of the system of FIG. 1;

FIG. 3 is a diagram of at least one embodiment of a robotic manufacturing system of FIG. 1;

FIGS. 4-8 are flowcharts of at least one embodiment of a method for performing diagnostic operations that may be executed by the system of FIG. 1;

FIGS. 9-15 are diagrams of user interfaces that may be produced by the system of FIG. 1; and

FIG. 16 is a diagram of diagnostic operations that may be performed by the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

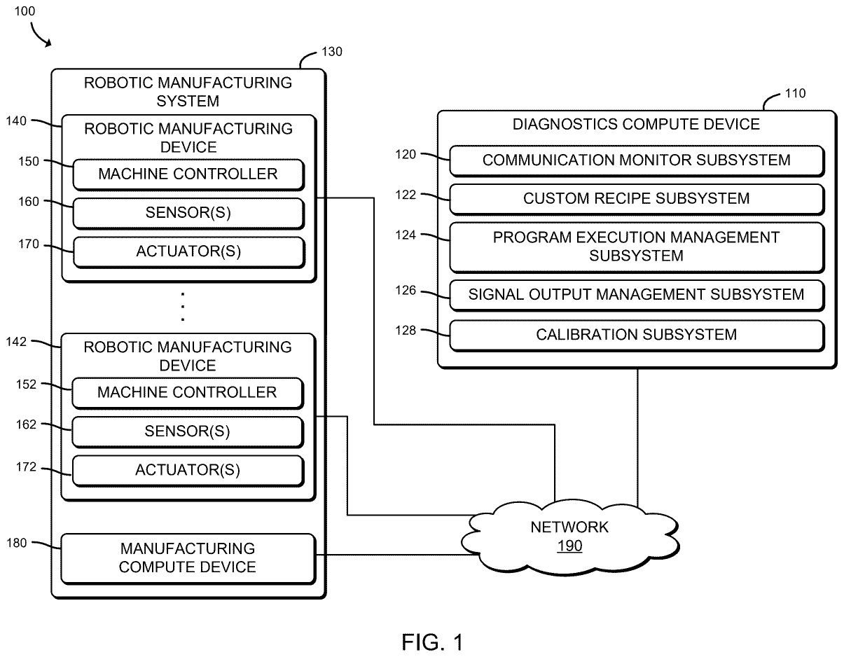

Referring now to FIG. 1, a system 100 for performing diagnostic operations includes, in the illustrative embodiment, a diagnostics compute device 110 communicatively connected to a robotic manufacturing system 130. The robotic manufacturing system 130, in the illustrative embodiment, includes a set of robotic manufacturing devices 140, 142 and a manufacturing compute device 180. The robotic manufacturing device 140, illustratively includes a machine controller 150 (e.g., a processor, a microcontroller, or other circuitry configured to control operations of the robotic manufacturing device 140). Further, the robotic manufacturing device 140 illustratively includes a set of one or more sensors 160. Each sensor 160 may be embodied as a device (e.g., a proximity sensor, a pressure sensor, an accelerometer, a magnetometer, a temperature sensor, a strain gauge load cell, or other device) capable of detecting a corresponding condition, such as the presence of an object, a distance between objects, an orientation of an object, a temperature, a force, or other condition. Further, the robotic manufacturing device 140 illustratively includes a set of one or more actuators 170. Each actuator 170 may be embodied as a device, such as an electric motor, a stepper motor, a hydraulic cylinder, a solenoid, a piezoelectric device, a servomotor, a screw jack, or an electroactive polymer, that effects a physical movement by converting energy (e.g., electrical, air, or hydraulic) into a mechanical force. Likewise, the robotic manufacturing device 142 may include a corresponding machine controller 152, a set of one or more sensors 162, and a set of one or more actuators 172. In use, the robotic manufacturing devices 140, 142 may perform a series of operations to produce a corresponding product used in construction (e.g., a structure, such as a roof truss, a floor truss, a wall panel, an engineered wood product, or other building component). In at least some embodiments, while individual operations may be directed by a machine controller 150, 152 of a corresponding robotic manufacturing device 140, 142 (e.g., based on a corresponding control program), the operations across the robotic manufacturing system 130 may be defined at a higher level of abstraction based on a recipe (e.g., a set of operations to be performed by the robotic manufacturing devices 140, 142) generated by a manufacturing compute device 180 (e.g., based on job data that indicates a number and type of products (e.g., structures) to be manufactured by the robotic manufacturing system 130).

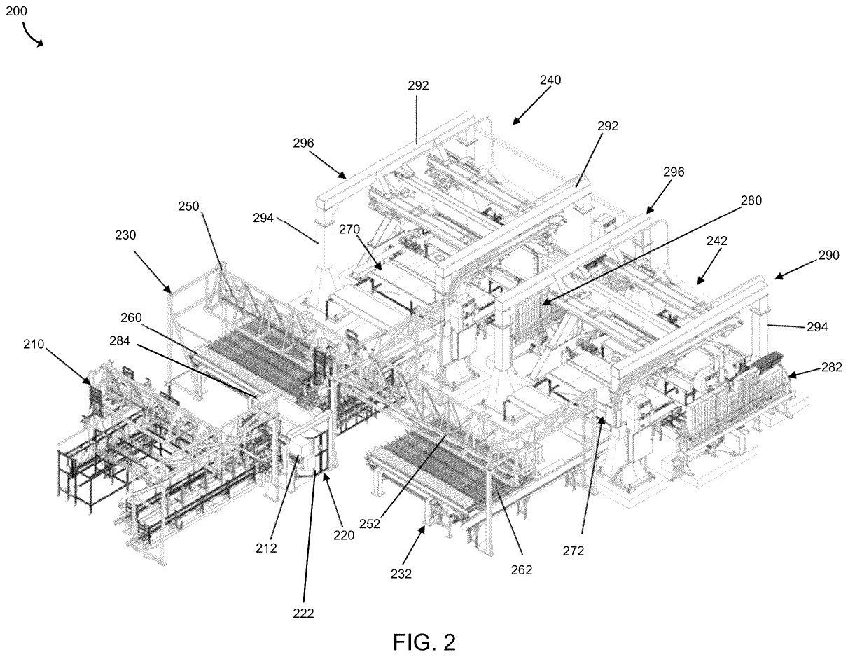

Referring briefly to FIG. 2, an embodiment a robotic manufacturing system 200 for producing building components (e.g., one or more roof trusses, floor trusses, wall panels, engineered wood products, other building components that may be premanufactured, or other structures), corresponding to the robotic manufacturing system 130 of FIG. 1, includes an infeed station 210, a cutting station 220, two buffer stations 230, 232, and two assembly stations 240, 242. The infeed station 210, in operation, receives stock lumber (e.g., wooden boards) and arranges the stock lumber to be cut into lumber pieces by a robotic saw 222 (a robotic manufacturing device 140, 142) in the cutting station 220. A fiducial printer 284 (a robotic manufacturing device 140, 142) is configured to print fiducial data (e.g., indicia) on stock lumber carried along in-feed lines as the stock lumber is being delivered to the cutting station 220. As described herein, the fiducial data facilitates robotic manufacture of the resulting structure, such as by enabling identification of the lumber (e.g., the grade, the length, etc.). Additionally, the robotic manufacturing system 200 includes multiple buffer stations 230, 232 that, in operation, receive pieces of cut lumber from the cutting station 220 (e.g., cut by the robotic saw 222). Each of the buffer stations 230, 232 includes a robotic manipulator assembly 250, 252 (each a robotic manufacturing device 140, 142) that transports cut lumber pieces from a waiting area to a corresponding buffer table 260, 262. Each assembly station 240, 242 includes an assembly module 270, 272 (each a robotic manufacturing device 140, 142) and a plate distribution module 280, 282 (each a robotic manufacturing device 140, 142). Each assembly module 270, 272 travels along rails 292 of a frame 290 made up of uprights 294 and supports 296, to position cut lumber pieces together. Each plate distribution module 280, 282, in turn, supplies nailing plates for fastening the cut lumber pieces together.

A component manufacture computing device 212 (similar to the manufacturing compute device 180) is connected to each station within the system 200 and controls the operation of the individual stations by creating a recipe (e.g., a series of operations) to produce a target set of structures (e.g., one or more roof trusses, floor trusses, wall panels, engineered wood products, other building components that may be premanufactured, or other structures) defined in a set of job data. The job data may be embodied as data encoded in an extensible markup language (XML) or other format that specifies types and amounts of structures to be manufactured. In at least some embodiments, the system 200 may have one or more of the features of the system described in commonly owned PCT/US2024/034758, entitled “AUTOMATED TRUSS MANUFACTURING AND ASSEMBLY SYSTEM”, which is incorporated by reference herein.

Referring back to FIG. 1, the diagnostics compute device 110, in the illustrative embodiment, includes a communication monitor subsystem 120, a custom recipe subsystem 122, a program execution management subsystem 124, a signal output management subsystem 126, and a calibration subsystem 128. Each subsystem 120, 122, 124, 126, 128 may be embodied as any device, circuity, software, or combination thereof (including virtualized versions thereof) configured to provide the functionality described herein. The communication monitor subsystem 120, in the illustrative embodiment, is configured to monitor input and output signals among the devices 140, 142, 180 of the robotic manufacturing system 130, including digital and/or analog signals. Further, the communication monitor subsystem 120 may selectively write to one or more registers (e.g., memory 314) of the robotic manufacturing devices 140, 142 (e.g., of the respective machine controllers 150, 152). Depending on the embodiment, the communication monitor subsystem 120 may have read and/or write access to one or more of numerical registers (NRs), string registers (SRs), digital input/output signals, robot input/output signals, group input/output signals, user input/output signals, system input/output signals, alarm data (e.g., a string providing a list of one or more alarms on a machine controller 150, 152), program data (e.g., a string providing a list and status of running/paused programs), and/or position data (e.g., data indicative of positions of one or more actuators 170, 172).

The custom recipe subsystem 122 is configured to obtain a custom recipe that utilizes a subset of the robotic manufacturing devices 140, 142 of the robotic manufacturing system 130 and cause the subset of the robotic manufacturing devices 140, 142 to execute the custom recipe in one of a set of modes (e.g., an iterative mode, an automatic mode, or a repeat mode) to evaluate the performance of one or more of the robotic manufacturing devices 140, 142 in carrying out operations in the custom recipe, without requiring the entire robotic manufacturing system 130 to execute the recipe. Further, the program execution management subsystem 124, in the illustrative embodiment, is configured to perform diagnostic operations pertaining to execution of one or more control programs associated with a target robotic manufacturing device 140, 142 (e.g., a specific one of the robotic manufacturing devices 140, 142). The operations may include managing individual motions and sensor(s) (e.g., one or more sensors 160), tracking active and inactive control programs, identifying paused lines of code and conditions for resumption of execution, providing simulated sensor data, selectively starting or stopping execution of control programs, or other operations as described in more detail herein.

In addition, the signal output management subsystem 126, in the illustrative embodiment, is configured to selectively operate one or more target actuators (e.g., one or more actuators 170) of a target robotic manufacturing device (e.g., the robotic manufacturing device 140), subject to interlock logic. The interlock logic, in the illustrative embodiment, is defined to prevent interference (e.g., collisions) between components of the robotic manufacturing system 130. Further, the calibration subsystem 128 is configured to perform calibration operations to adjust and test the effects of parameter settings of a target robotic manufacturing device 140, 142, without requiring an entire recipe to be executed across the robotic manufacturing system 130 under the adjusted parameters. Accordingly, and as compared to conventional systems, the system 100 enables efficient diagnostics to be performed in a complex robotic manufacturing system 130, such as by enabling expedient isolation of the source of a problem (e.g., a defect in a manufactured product) and individualized testing of operations and adjusted parameters of components of the robotic manufacturing system 130, without causing interference with other operations of the robotic manufacturing system 130.

While a relatively small number of devices 110, 140, 142, 150, 152, 160, 162, 170, 172, 180 are shown in FIG. 1 for simplicity and clarity, it should be understood that the number of devices, in practice, may range in the tens, hundreds, thousands, or more. Likewise, it should be understood that the devices 110, 140, 142, 150, 152, 160, 162, 170, 172, 180 may be distributed differently or perform different roles than the configuration shown in FIG. 1. Further, though shown as separate devices 110, 140, 142, 150, 152, 160, 162, 170, 172, 180 in some embodiments, the functionality of one or more of the devices 110, 140, 142, 150, 152, 160, 162, 170, 172, 180 may be combined into fewer devices and/or distributed across more devices than those shown in FIG. 1.

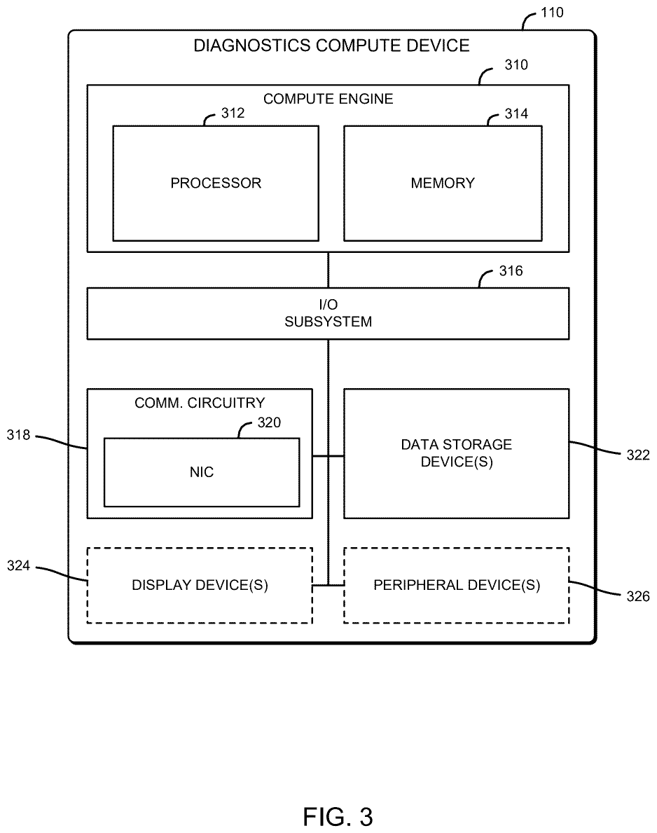

Referring now to FIG. 3, an illustrative embodiment of the diagnostics compute device 110, includes a compute engine 310, an input/output (I/O) subsystem 316, communication circuitry 318, and one or more data storage devices 322. In some embodiments, the diagnostics compute device 110 may include one or more display devices 324 and/or one or more peripheral devices 326 (e.g., a mouse, a physical keyboard, etc.). In some embodiments, one or more of the illustrative components may be incorporated in, or otherwise form a portion of, another component. The compute engine 310 may be embodied as any type of device or collection of devices capable of performing various compute functions. In some embodiments, the compute engine 310 may be embodied as a single device such as an integrated circuit, an embedded system, a field-programmable gate array (FPGA), a system-on-a-chip (SOC), or other integrated system or device. Additionally, in the illustrative embodiment, the compute engine 310 includes or is embodied as at least one processor 312 and a memory 314. The processor 312 may be embodied as any type of processor capable of performing the functions described herein. For example, the processor 312 may be embodied as a single or multi-core processor(s), a microcontroller, or other processor or processing/controlling circuit. In some embodiments, the processor 312 may be embodied as, include, or be coupled to an FPGA, an application specific integrated circuit (ASIC), one or more graphics processing units (GPUs), neural processing units (NPUs), and/or floating point units (FPUs), reconfigurable hardware or hardware circuitry, or other specialized hardware to facilitate performance of the functions described herein.

In embodiments, the processor 312 is capable of receiving, e.g., from the memory 314 or via the I/O subsystem 316, a set of instructions which when executed by the processor 312 cause the diagnostics compute device 110 to perform one or more operations described herein. In embodiments, the processor 312 is further capable of receiving, e.g., from the memory 314 or via the I/O subsystem 316, one or more signals from external sources, e.g., from the peripheral devices 326 or via the communication circuitry 318 from an external compute device, external source, or external network. As one will appreciate, a signal may contain encoded instructions and/or information. In embodiments, once received, such a signal may first be stored, e.g., in the memory 314 or in the data storage device(s) 322, thereby allowing for a time delay in the receipt by the processor 312 before the processor 312 operates on a received signal. Likewise, the processor 312 may generate one or more output signals, which may be transmitted to an external device, e.g., an external memory or an external compute engine via the communication circuitry 318 or, e.g., to one or more display devices 324. In some embodiments, a signal may be subjected to a time shift in order to delay the signal. For example, a signal may be stored on one or more storage devices 322 to allow for a time shift prior to transmitting the signal to an external device. One will appreciate that the form of a particular signal will be determined by the particular encoding a signal is subject to at any point in its transmission (e.g., a signal stored will have a different encoding than a signal in transit, or, e.g., an analog signal will differ in form from a digital version of the signal prior to an analog-to-digital (A/D) conversion).

The main memory 314 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 314 may be integrated into the processor 312. In operation, the main memory 314 may store various software and data used during operation such as monitored communication data, register values, custom recipe data, interlock logic, log data, applications, libraries, and drivers.

The compute engine 310 is communicatively coupled to other components of the diagnostics compute device 110 via the I/O subsystem 316, which may be embodied as circuitry and/or components to facilitate input/output operations with the compute engine 310 (e.g., with the processor 312 and the main memory 314) and other components of the diagnostics compute device 110. For example, the I/O subsystem 316 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 316 may form a portion of a system-on-a-chip (SoC) and be incorporated, along with one or more of the processor 312, the main memory 314, and other components of the diagnostics compute device 110, into the compute engine 310.

The communication circuitry 318 may be embodied as any communication circuit, device, or collection thereof, capable of enabling communication over a network between the diagnostics compute device 110 and another device (e.g., a device 140, 142, 150, 152, 160, 162, 170, 172, 180, etc.). The communication circuitry 318 may be configured to use any one or more communication technology (e.g., wired or wireless communications) and associated protocols (e.g., Ethernet, Wi-Fi®, WiMAX, Bluetooth®, etc.) to effect such communication. In some embodiments, the communication circuitry 318 may support communications via one or more of OPCUA (open platform communications unified architecture), EEIP (ethernet/internet protocol), and/or FTP (file transfer protocol) for data exchange.

The illustrative communication circuitry 318 includes a network interface controller (NIC) 320. The NIC 320 may be embodied as one or more add-in-boards, daughter cards, network interface cards, controller chips, chipsets, or other devices that may be used by the diagnostics compute device 110 to connect with another device (e.g., a device 140, 142, 150, 152, 160, 162, 170, 172, 180 etc.). In some embodiments, the NIC 320 may be embodied as part of a system-on-a-chip (SoC) that includes one or more processors, or included on a multichip package that also contains one or more processors. In some embodiments, the NIC 320 may include a local processor (not shown) and/or a local memory (not shown) that are both local to the NIC 320. Additionally or alternatively, in such embodiments, the local memory of the NIC 320 may be integrated into one or more components of the diagnostics compute device 110 at the board level, socket level, chip level, and/or other levels.

Each data storage device 322, may be embodied as any type of device configured for short-term or long-term storage of data such as, for example, memory devices and circuits, memory cards, hard disk drives, solid-state drives, or other data storage devices. Each data storage device 322 may include a system partition that stores data and firmware code for the data storage device 322 and one or more operating system partitions that store data files and executables for operating systems.

Each display device 324 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 324 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the diagnostics compute device 110 are housed in a single unit. However, in other embodiments, the components may be in separate housings. The other devices 140, 142, 180 may include components similar to those of the diagnostics compute device 110. Further, the devices 140, 142, 180 may include other components, sub-components, and devices commonly found in a computing device, which are not discussed above in reference to the diagnostics compute device 110 and not discussed herein for clarity of the description.

In the illustrative embodiment, the devices 110, 140, 142, 180 are in communication via a network 190, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

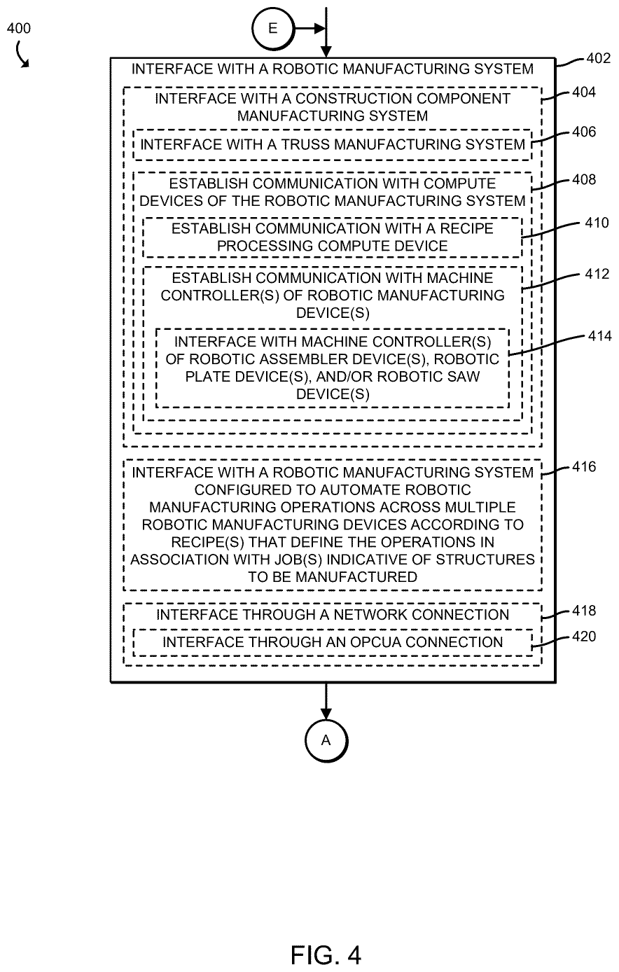

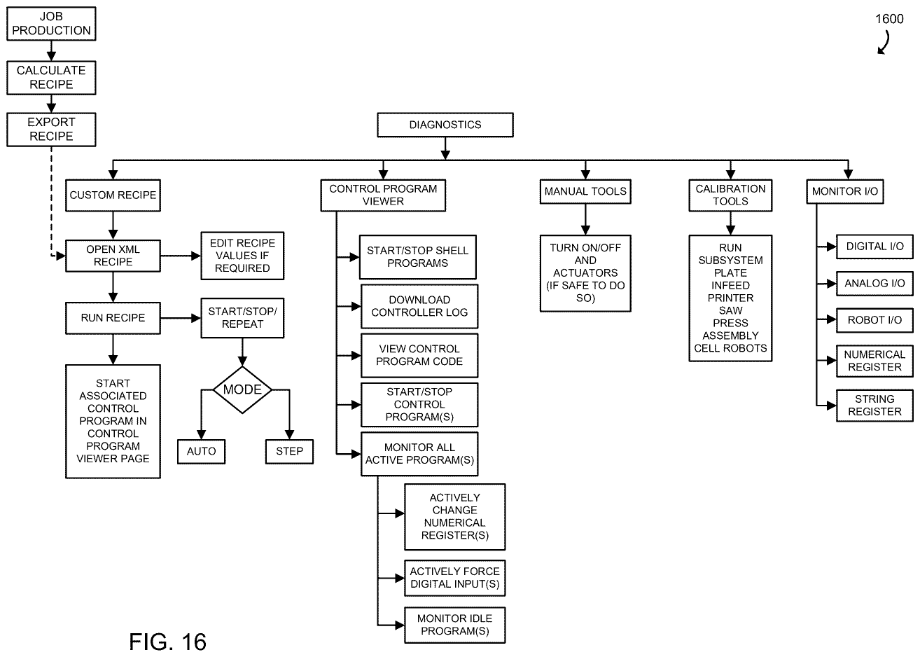

Referring now to FIG. 4, the system 100 (e.g., the diagnostics compute device 110) may perform a method 400 for performing efficient diagnostic operations in connection with a robotic manufacturing system, such as the robotic manufacturing system 130. A high level view of at least some embodiments of operations corresponding with the method 400 is shown in the diagram 1600 of FIG. 16. The operations are described herein as being performed in connection with physical devices of the robotic manufacturing system 130. However, in some embodiments, the diagnostics compute device 110 may perform the operations in connection with a digital twin of the robotic manufacturing system 130. A digital twin may be embodied as a virtual representation of an object or system designed to accurately reflect the properties and functionality of the physical object or system. The method 400, in the illustrative embodiment, begins with block 402 in which the diagnostics compute device 110 interfaces with a robotic manufacturing system (e.g., the robotic manufacturing system 130). In doing so, and as indicated in block 404, the diagnostic compute device 110 may interface with a building component manufacturing system (e.g., the robotic manufacturing system 130 may be configured to manufacture one or more components used in building construction). In doing so, and as indicated in block 406, the diagnostics compute device 110 may interface with a building component manufacturing system (e.g., the robotic manufacturing system 130, in at least some embodiments, is a building component manufacturing system). As indicated in block 408, the diagnostics compute device 110 may establish communication with one or more compute devices of the robotic manufacturing system 130. The diagnostics compute device 110 may establish communication with a recipe processing compute device (e.g., the manufacturing compute device 180), as indicated in block 410. That is, in at least some embodiments, the diagnostics compute device 110 may establish communication with a compute device configured to produce a recipe (e.g., a set of operations to be performed by the robotic manufacturing devices, such as the robotic manufacturing devices 140, 142) based on job data that indicates a number and type of products (e.g., structures) to be manufactured.

As indicated in block 412, the diagnostics compute device 110 may additionally or alternatively establish communication with one or more machine controllers 150, 152 of robotic manufacturing devices 140, 142. In doing so, the diagnostics compute device 110 may interface with machine controllers 150, 152 of one or more robotic assembler devices, such as one or more assembly modules 270, 272, one or more robotic plate devices, such as one or more plate distribution modules 280, 282, and/or one or more robotic saw devices (e.g., the robotic saw 222), as indicated in block 414. The diagnostics compute device 110 may interface with a robotic manufacturing system configured to automate robotic manufacturing operations across multiple robotic manufacturing devices according to one or more recipes that define the operations in association with one or more jobs indicative of structure(s) (e.g., one or more roof trusses, floor trusses, wall panels, engineered wood products, other building components that may be premanufactured, or other structures) to be manufactured, as indicated in block 416. In the illustrative embodiment, the diagnostics compute device 110 may, in establishing communication, interface with the robotic manufacturing system 130 through a network connection (e.g., via the network 190), as indicated in block 418. For example, in some embodiments, the diagnostics compute device 110 may interface through an open platform communications unified architecture (OPCUA) connection, as indicated in block 420. Additionally or alternatively, the diagnostics compute device 110 may interface through EEIP, FTP, and/or other data exchange protocol(s).

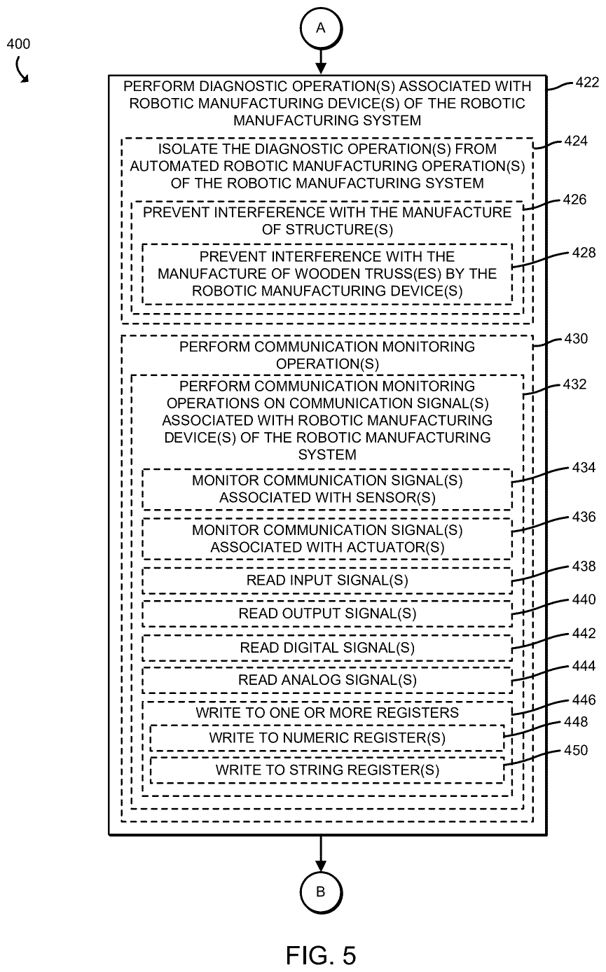

Referring now to FIG. 5, after communication with the robotic manufacturing system 130 has been established, the method 400, in the illustrative embodiment, advances to block 422 in which the diagnostics compute device 110 performs one or more diagnostic operations associated with one or more robotic manufacturing devices 140, 142 of the robotic manufacturing system 130. In doing so, and as indicated in block 424, the diagnostics compute device 110 may isolate the diagnostic operation(s) from any automated robotic manufacturing operations of the robotic manufacturing system (e.g., ongoing operations performed according to one or more recipes). The diagnostics compute device 110 may prevent interference with the manufacture of one or more structures (e.g., defined in a set of job data), as indicated in block 426. For example, and as indicated in block 428, the diagnostics compute device 110 may prevent interference with the manufacture of one or more building components (e.g., defined in a set of job data) by the robotic manufacturing devices 140, 142 of the robotic manufacturing system 130. As described herein, the diagnostic systems and methods are applicable to systems that manufacture any suitable building component including but not limited to floor trusses, roof trusses, wall panels, engineered wood products (EWPs), open web floor trusses, I-joists, rimboards, glued laminated timber (GLULAMS), laminated veneer lumber (LVL), laminated strand lumber (LSL), structural connectors and reinforcements, and framing technologies. In performing the diagnostic operation(s), in block 430, the diagnostics compute device 110 may perform one or more communication monitoring operations (e.g., with the communication monitor subsystem 120).

As indicated in block 432, the diagnostics compute device 110 may perform communication monitoring operations on one or more communication signals associated with robotic manufacturing devices 140, 142 of the robotic manufacturing system 130. For example, the diagnostics compute device 110 may monitor communication signals associated with one or more sensors 160, 162, as indicated in block 434. Those signals may indicate the presence of lumber at a defined location (e.g., in an infeed section associated with a robotic saw), an image of a symbol or set of symbols (e.g., fiducial data) printed on a piece of lumber, indicative of one or more characteristics of the piece of lumber (e.g., the grade, the length, etc.), a proximity of one robotic component to another robotic component (e.g., a distance between two opposing elements of a gripping mechanism, such as opposing elements of clamps), a suction force applied to a piece of lumber, or other data. Operations of robotic manufacturing devices 140, 142 may be determined as a function of the presence and values of (e.g., data represented by) signals associated with one or more of the sensors 160, 162. Accordingly, by monitoring the signals, the diagnostics compute device 110 may provide improved analysis of the reasons why a particular robotic operation is performed in a particular way (e.g., at a particular position in space, at a particular time, etc.) or is not occurring at all (e.g., if an expected signal from a sensor 160, 162 is not being transmitted).

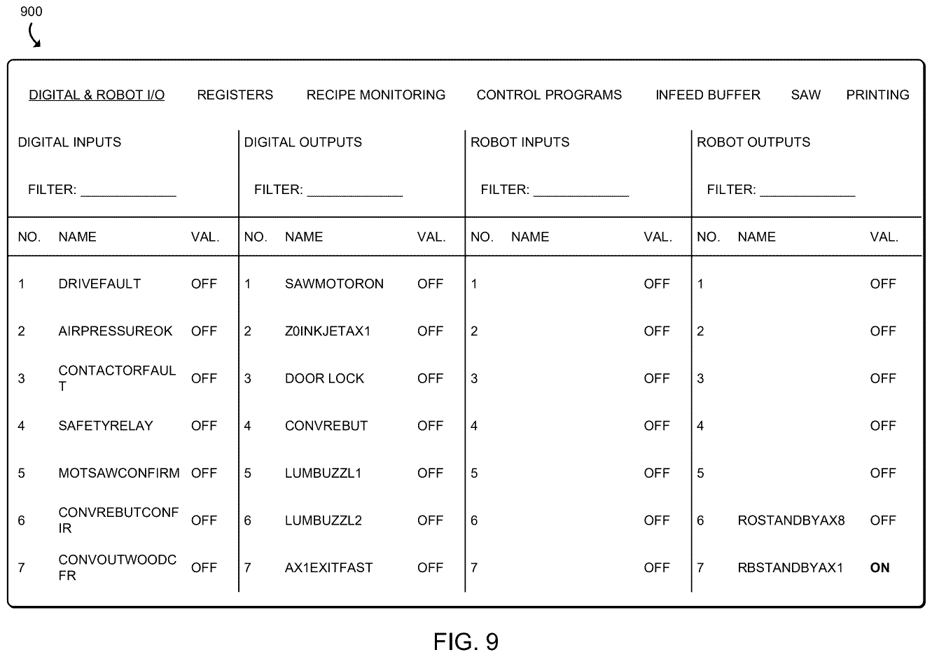

Similarly, the diagnostics compute device 110 may monitor communication signals associated with one or more actuators 170, 172, as indicated in block 436. The signals may be sent from a corresponding machine controller 150, 152 to cause a particular movement, such as gripping or applying suction to a piece of lumber at a defined location, picking up a piece of lumber, dropping a piece of lumber at a defined location, cutting a piece of lumber, applying a nailing plate at an intersection between multiple pieces of lumber, actuating a press, and/or other movements. The diagnostics compute device 110 may read input signals and output signals, including digital signals and/or analog signals, as indicated in blocks 438, 440, 442, 444 associated with the robotic manufacturing devices 140, 142 and any components thereof (e.g., the machine controllers 150, 152, the sensors 160, 162, the actuators 170, 172) in the robotic manufacturing system 130. FIG. 9 represents an embodiment of a user interface 900 that may be presented by the diagnostics compute device 110 to monitor communication signals in accordance with the above operations.

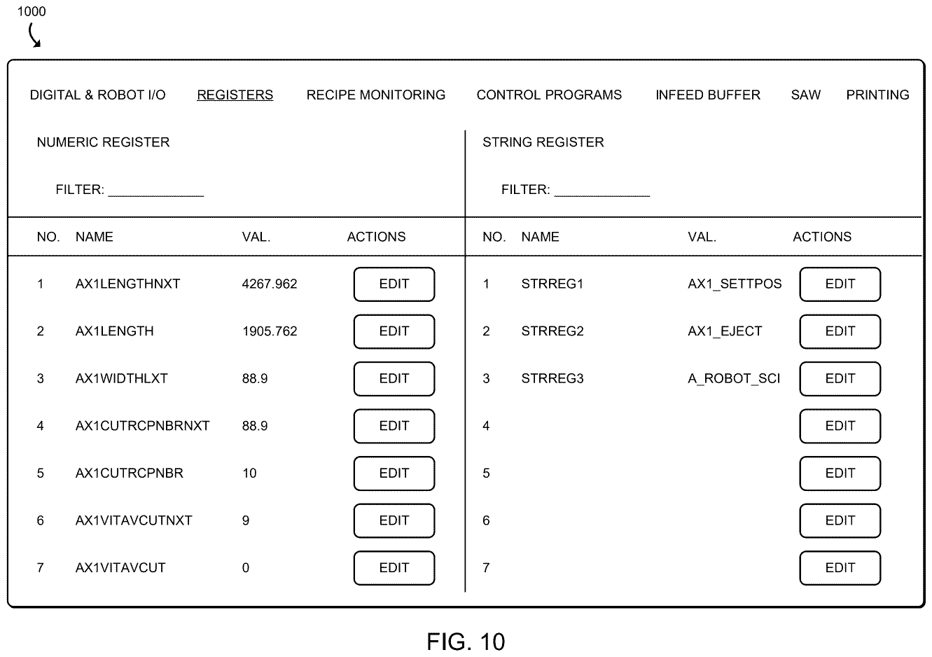

Further, the diagnostics compute device 110 may write to one or more registers (e.g., reserved portions of memory 314 for data or instructions), such as one or more registers of the machine controllers 150, 152, as indicated in block 446. In doing so, the diagnostics compute device 110 may write to one or more numeric registers, as indicated in block 448 or one or more string registers, as indicated in block 450, e.g., to simulate input from another device and/or otherwise provide data for the machine controller 150, 152 to respond to (e.g., according to a control program). An embodiment of a user interface 1000 that may be produced by the diagnostics compute device 110 for viewing and/or editing the values of numeric and string registers is shown in FIG. 10.

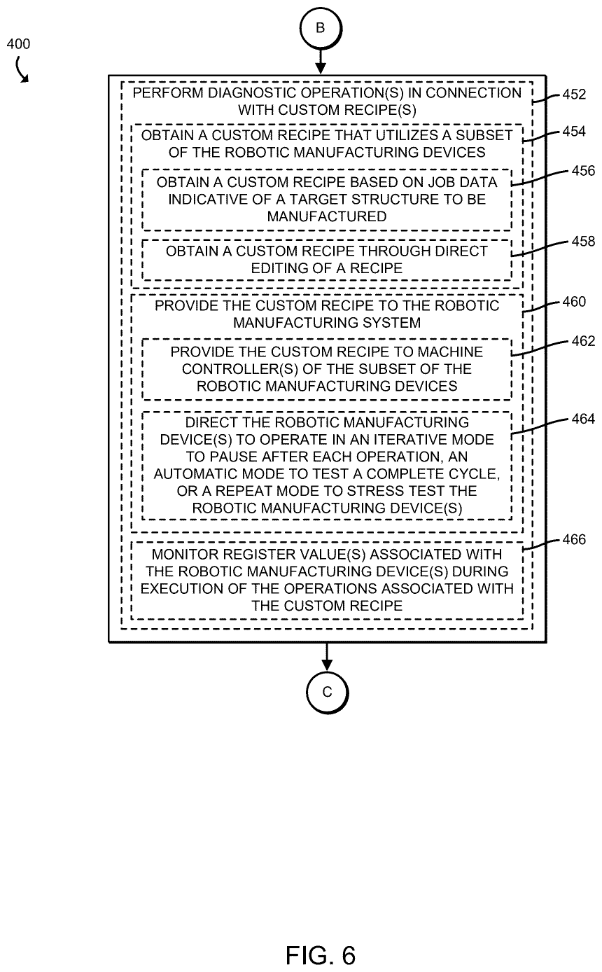

Referring now to block 452 of FIG. 6, the diagnostics compute device 110 may additionally or alternatively perform one or more diagnostic operations in connection with one or more custom recipes (e.g., using the custom recipe subsystem 122). As discussed above, and as indicated in block 454, a custom recipe may be embodied as a set of operations to be performed by a subset of the robotic manufacturing devices 140, 142 of the robotic manufacturing system 130, to produce a corresponding product (e.g., a structure, such as a roof truss, a floor truss, a wall panel, an engineered wood product, or other building component) or a portion thereof. As indicated in block 456, the diagnostics compute device 110 may obtain a custom recipe based on job data that indicates (e.g., by a product identifier, a diagram, etc.) a target structure to be manufactured. A process for creating a recipe from job data is described in commonly owned PCT/US2024/034758, which is incorporated by reference herein. The diagnostic compute device 110 may alternatively obtain a custom recipe through direct editing (e.g., in a text editor or similar editor) of a recipe (e.g., from a new file or a pre-existing recipe file), rather than executing a process to produce a recipe from a set of job data, as indicated in block 458. In some embodiments, a job management service may import a job and calculate one or more recipes. A resulting recipe may be queued for normal operation of the robotic manufacturing system 130 or exported as custom recipe. For example, a saw recipe (e.g., defining operations of the robotic saw 222) and/or a plate recipe (e.g., defining operations of one or more of the plate distribution modules 280, 282) may be exported as custom recipes. The custom recipes may, in some embodiments, be encoded in a textual format, such as comma separated values (CSV) or otherwise (e.g., XML) and may be loaded into the diagnostics compute device 110 (e.g., in the memory 314). In a textual format (e.g., CSV, XML, etc.) a custom recipe can be easily edited by a user with a corresponding editor (e.g., a text editor, a CSV editor, an XML editor, etc.). In other embodiments, the custom recipe may be encoded in a non-textual format and may be edited with a corresponding editor configured to parse the non-textual format.

As indicated in block 460, the diagnostics compute device 110 may provide the custom recipe to the robotic manufacturing system 130 (e.g., via the network 190). In doing so, in block 462, the diagnostics compute device 110 may provide the custom recipe to machine controllers 150, 152 of the subset of the robotic manufacturing devices 140, 142 to be utilized, according to the custom recipe. In some embodiments, the diagnostics compute device 110 may provide only the portion(s) of the custom recipe that are to be executed by the corresponding machine controller 150, 152, so that a machine controller 150, 152 does not receive instructions for performing operations that are to be performed by another machine controller 150, 152. As indicated in block 464, the diagnostics compute device 110 may direct (e.g., through a separate communication, as a parameter of an application programming interface call, or otherwise) the robotic manufacturing devices 140, 142 to operate in an iterative mode. In an iterative mode, the robotic manufacturing device 140, 142 pauses after each operation indicated in the custom recipe.

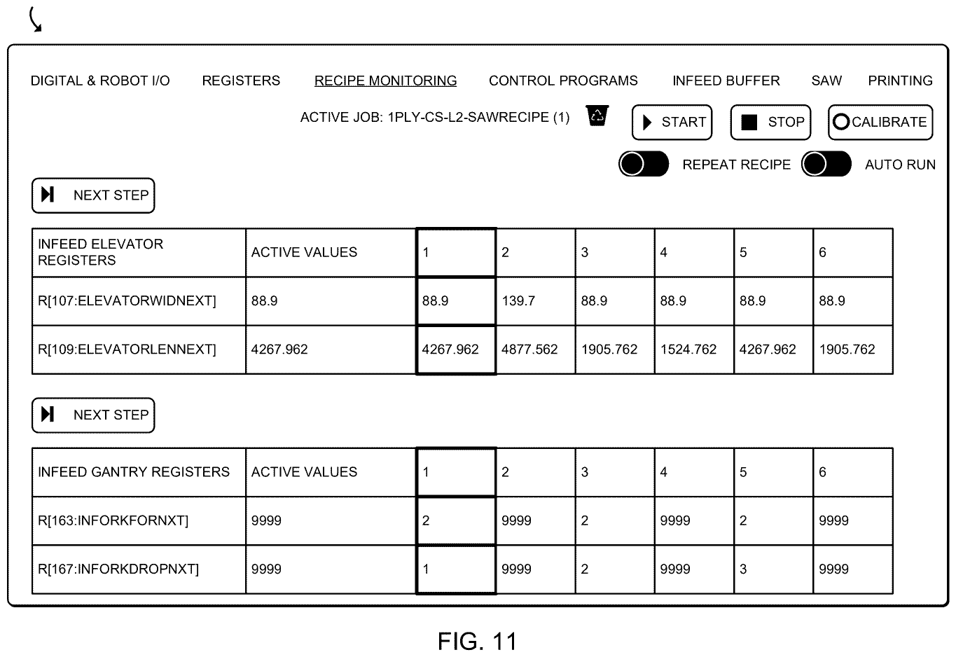

Alternatively, the diagnostics compute device 110 may direct the robotic manufacturing devices 140, 142 to operate in an automatic mode. In an automatic mode, the robotic manufacturing devices 140, 142 perform the operation in the custom recipe without pausing after each instruction. Doing so enables testing of a complete cycle (e.g., execution of all of the operations in the custom recipe) at the speed those operations would be performed in a production context (e.g., at a “normal” speed). Testing a full cycle may reveal complications (e.g., warping due to heat buildup, inability to perform rapid changes in speed/direction of robotic components due to inertia, etc.) that do not arise when a pause exists between operations. Alternatively, the diagnostics compute device 110 may direct the robotic manufacturing devices 140, 142 to operate in a repeat mode. In a repeat mode, the robotic manufacturing devices 140, 142 repeatedly perform (e.g., a defined number of times or until instructed otherwise) the operations defined in the custom recipe. The repeat mode enables stress testing of the robotic manufacturing devices 140, 142. Stress testing may reveal complications resulting from a buildup of heat that may cause warping or deformation of materials, imprecise positionings that have a cumulative effect that eventually exceeds a tolerance, or other issues. As indicated in block 466, the diagnostics compute device 110 may monitor register value(s) (e.g., in the memories 314 of the corresponding machine controllers 150, 152) associated with the robotic manufacturing devices 140, 142 during execution of the operations associated with the custom recipe. By doing so, the diagnostics compute device 110 may determine whether the register values indicate that an error has occurred (e.g., as determined by the corresponding control program). For example, if an incorrect board size is fed, the control program may trigger an error, changing the value in a corresponding numerical register. The robotic manufacturing device 140, 142 may then wait for a user to respond to the error, prompting a message in a user interface for the user to act by modifying the value of the numerical register. An embodiment of a user interface 1100 that may be produced by the diagnostics compute device 110 for performing diagnostic operations in connection with custom recipes is shown in FIG. 11.

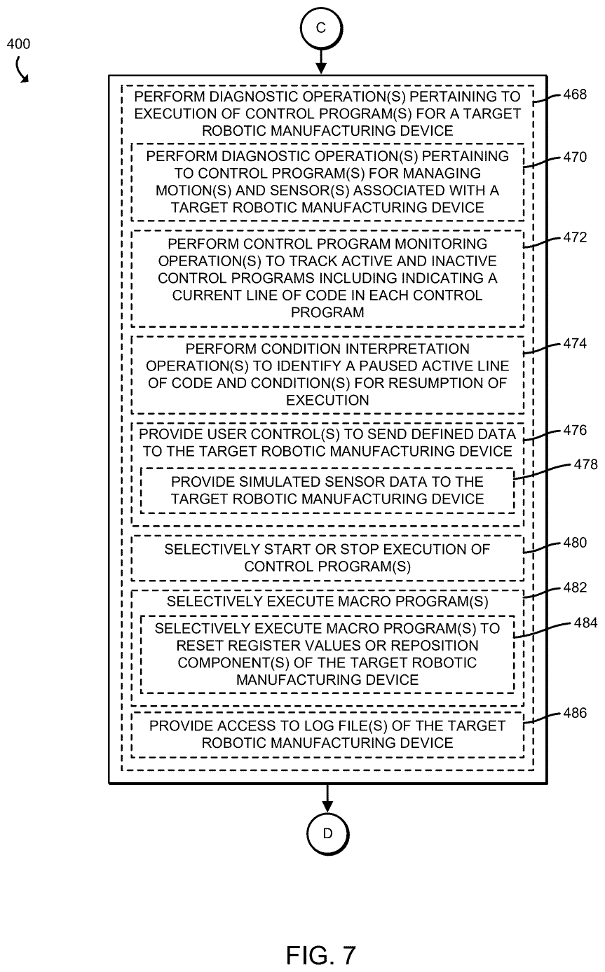

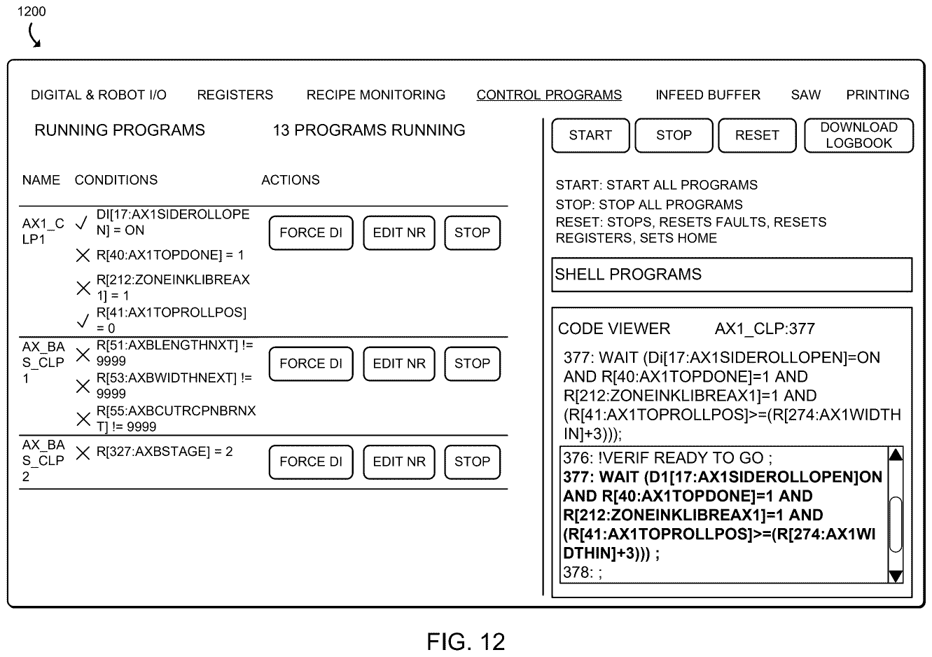

Referring now to FIG. 7, the diagnostics compute device 110 may perform diagnostic operations pertaining to execution of one or more control programs (e.g., FANUC teach pendant (TP) programs, ABB RAPID programs, or other robotic control programs) for a target robotic manufacturing device 140, 142, as indicated in block 468. The diagnostics compute device 110 may perform diagnostic operations pertaining to one or more control programs for managing motions (e.g., activations of actuators 170, 172) and/or sensors (e.g., data from one or more sensors 160, 162) associated with a target robotic manufacturing device 140, 142, as indicated in block 470. Further, as indicated in block 472, the diagnostics compute device 110 may perform control program monitoring operations to track active and inactive control programs, as indicated in block 472. In doing so, the diagnostics compute device 110 may indicate the current line of code in each control program (e.g., based on a program counter register). Indicating the current line of code enables the physical state of the target robotic manufacturing device 140, 142, as well as any output signals, input signals, and register values, to be easily correlated with a specific operation or determination within a control program. Similarly, the diagnostics compute device 110 may perform condition interpretation operations to identify a paused line of code in an active control program, as indicated in block 474. Further, the diagnostics compute device 110 may determine the condition(s) on which resumption of execution (e.g., unpausing) depends. A control program may be paused, awaiting an input signal from a particular sensor 160, 162 or a combination of input signals from multiple sensors 160, 162. For example, the control program may be paused awaiting signals from each of two sensors 160, 162, indicating the presence of a corresponding piece of lumber to be added to a joint of a structure (e.g., with a nailing plate or other fastener). In at least some embodiments, the system 100 (e.g., the diagnostics compute device 110) may collect and store parameter files and control programs from each machine controller 150, 152. Doing so facilitates the display of the description of all I/O and data, as well as the code lines of the control programs, as shown in the user interface 1200 of FIG. 12. The files may be updated by creating a data connection (e.g., an FTP connection) with the machine controller 150, 152 to download the latest version(s) of the control program(s), which may be written to one or more data storage devices 322.

As indicated in block 476, the diagnostics compute device 110 may provide user controls to enable sending defined data to the target robotic manufacturing device 140, 142. For example, the diagnostics compute device 110 may provide a user interface that enables a user to selectively indicate data to be sent to a target robotic manufacturing device 140, 142. In doing so, in block 478, the diagnostics compute device 110 may provide simulated sensor data to the target robotic manufacturing device 140, 142. For example, the diagnostics compute device 110 may send a signal or set a corresponding register value in memory 314 (e.g., reserved for input data from the sensor 160) indicating the presence of a piece of lumber at a particular position. In response, the target robotic manufacturing device 140 may send an output signal to an actuator 170 (e.g., a press), even when the piece of lumber is not actually present. By enabling sensor signals to be simulated within the robotic manufacturing system 130, the diagnostics compute device 110 may allow individual operations to be tested in isolation, rather than requiring an entire manufacturing process to be initiated. Further, simulating sensor signals may enable rapid identification of certain combinations of sensor signals that could result in unintended effects (e.g., unintended activation of an actuator 170). The diagnostics compute device 110 may selectively start or stop execution of one or more control programs, as indicated in block 480.

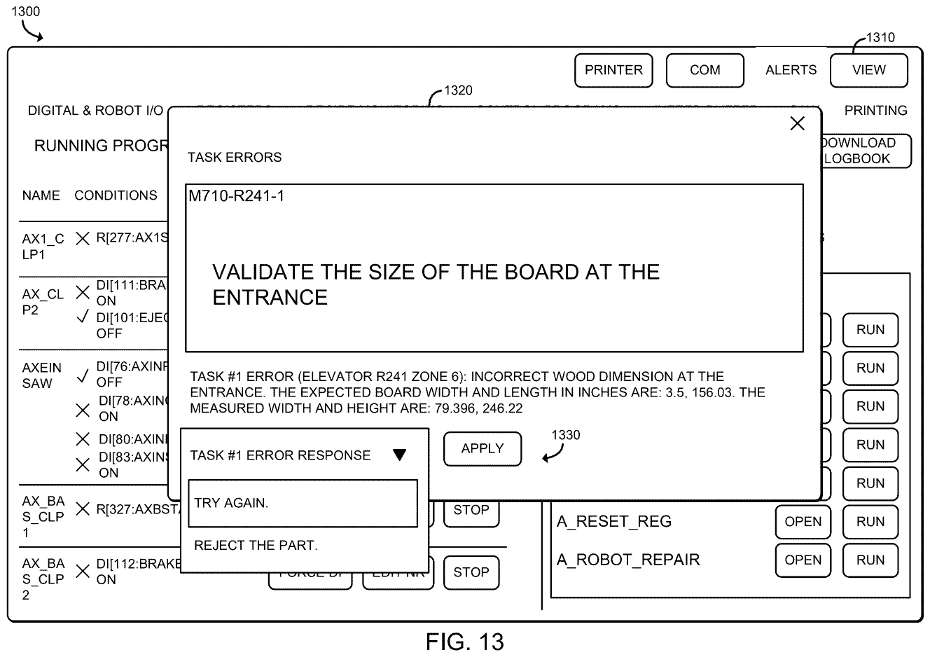

The diagnostics compute device 110 may selectively execute macro programs (e.g., shell programs), as indicated in block 482. For example, and as indicated in block 484, the diagnostics compute device 110 may selectively execute macro programs to reset register values and/or reposition component(s) of the target robotic manufacturing device 140, 142, as indicated in block 484. The diagnostics compute device 110 may also provide access to one or more log files of the target robotic manufacturing device 140, 142, as indicated in block 486. Doing so provides access to a record of operations performed by the robotic manufacturing device 140, 142, error(s) encountered by the robotic manufacturing device 140, 142, register values, input signals, output signals, and time stamps associated therewith. By providing fine grained control over control programs and individual lines of code within the control programs, the diagnostics compute device 110 may enable determination of the root cause of anomalies, such as unexpected robotic movements (e.g., activation of one or more actuators 170) that may otherwise be difficult or impossible to determine during a complex manufacturing process (e.g., according to a recipe) with multiple interacting robotic manufacturing devices 140, 142. An embodiment of a user interface 1200 that may be produced by the diagnostics compute device 110 for use in performing diagnostic operations in connection with control programs (e.g., in accordance with the operations described above), is shown in FIG. 12. In a scenario in which a board having an incorrect size is received by a robotic manufacturing device 140, 142, the user interface 1200 may display a message indicating “|A_infeed|Wait R[241]≠0|Edit NR”. In response, a user may change the value of R241 to 1 or 2, where 1 means try again and 2 means reject the part (e.g., the board). In at least some embodiments, the diagnostics compute device 110 may manage data indicative of faults and alarms. The diagnostics compute device 110 may monitor numerical registers for control program errors and I/O for system faults, such as low pressure, safety relay issues, and/or open doors. Two numerical registers may be used for each system error. For example, the first numerical register, ErrCodeTskx, may be 0 if no error is present, and non-zero if an error is present, with the non-zero value indicating the specific error type. The second numerical register, actionAfterErrTskx, may indicate how the user is resolving the error. In at least some embodiments, the diagnostics compute device 110 may present a user interface 1300 with a button 1310 that, when pressed, causes a dialogue box 1320 to appear, providing a description of the error and options 1330 to clear the error, as shown in FIG. 13.

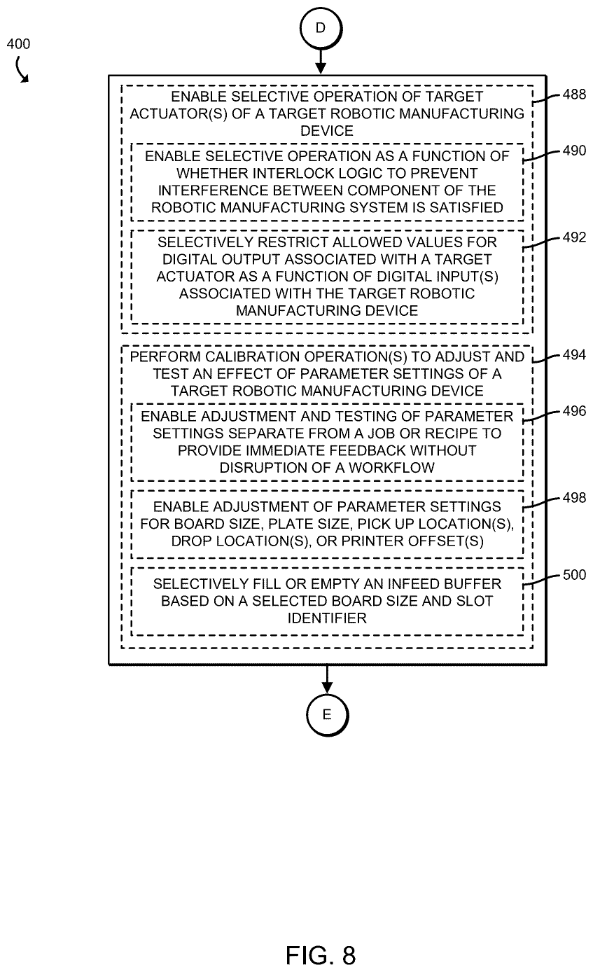

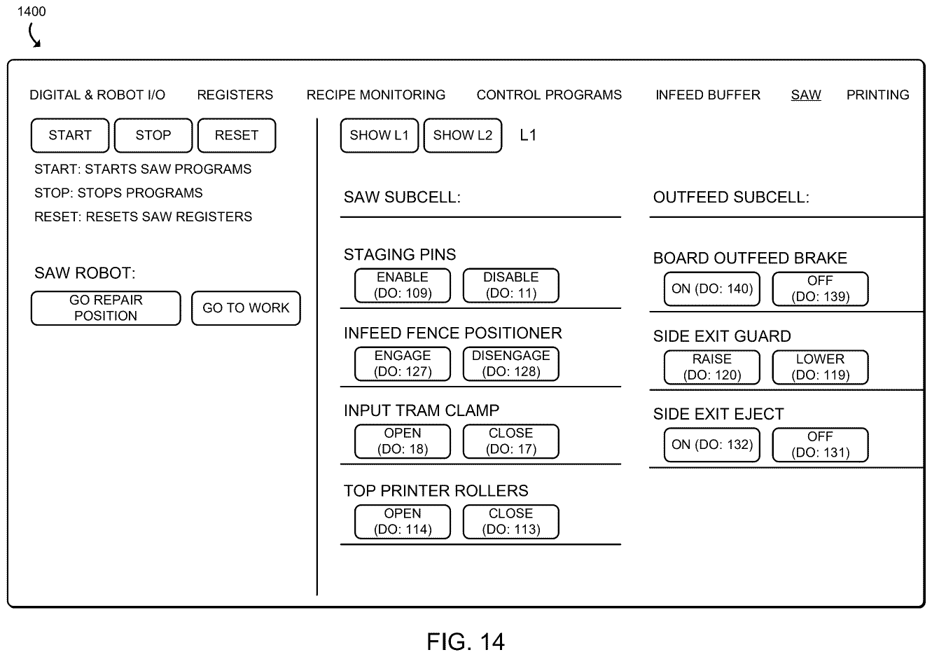

Referring now to FIG. 8, as indicated in block 488, the diagnostics compute device 110 may enable selective operation of target actuators 170, 172 of a target robotic manufacturing device 140, 142 (e.g., using the signal output management subsystem 126). In doing so, and as indicated in block 490, the diagnostics compute device 110 may enable selective operation (e.g., of actuators 170, 172) as a function of whether interlock logic is satisfied. The interlock logic, in the illustrative embodiment, is executable code defined to prevent interference between components of the robotic manufacturing system 130. As an example, the diagnostics compute device 110 may allow an actuator 170 to be activated in response to a determination that doing so will not cause a collision or other interference with an end effector or other component of a robotic manufacturing device 140, 142 in the robotic manufacturing system 130. As indicated in block 492, the diagnostics compute device 110 may selectively restrict allowed values (e.g., digital values) for output associated with a target actuator 170, 172 as a function of digital input(s) associated with the target robotic manufacturing device 140, 142. That is, the diagnostics compute device 110 may determine whether one or more sensors 160, 162 have output a value determined to indicate a safe state, before expanding the range of available values that may be sent to an actuator 170, 172. As an example, the diagnostics compute device 110 may restrict an activation signal, such as a digital one, from being sent to an actuator 170, 172 (e.g., a plate dispenser or press) until input sensor values satisfy corresponding criteria (e.g., indicating that corresponding pieces of lumber are present at defined locations, to be joined together with a nailing plate). An embodiment of a user interface 1400 that may be produced by the diagnostics compute device 110 for selective operation of target actuator(s) 170, 172 is shown in FIG. 14.

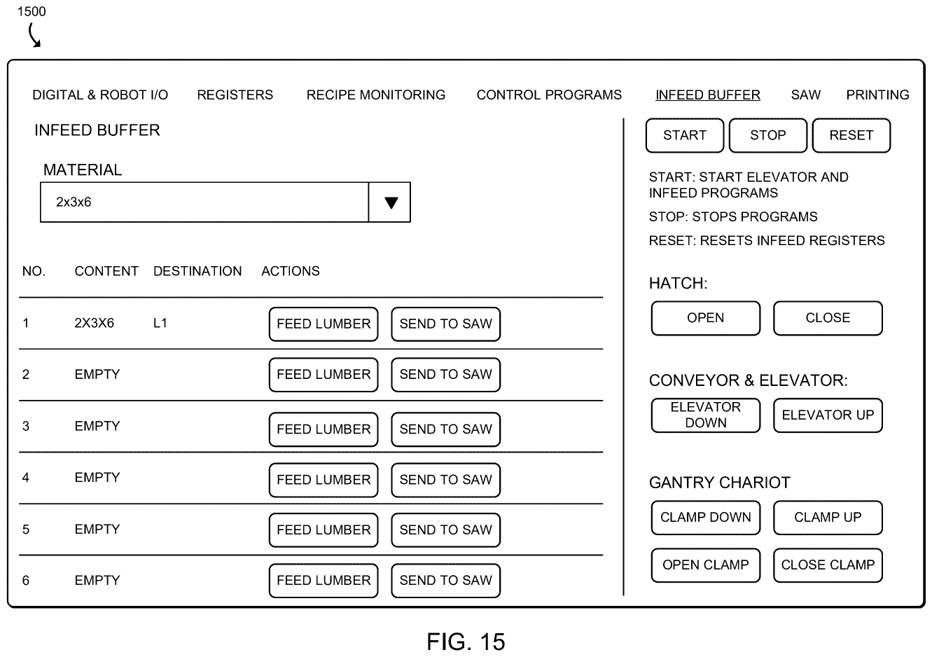

The diagnostics compute device 110 may perform (e.g., with the calibration subsystem 128) one or more calibration operations to adjust and test an effect of parameter settings of a target robotic manufacturing device 140, 142, as indicated in block 494. In doing so, and as indicated in block 496, the diagnostics compute device 110 may enable adjustment and testing of parameter settings separate from a job or recipe, to provide immediate feedback without disruption of a workflow. In at least some embodiments, the diagnostics compute device 110 may enable adjustment of parameter settings for board size, plate size, pick up location(s), drop location(s), and/or printer offsets, as indicated in block 498. In some embodiments, the diagnostics compute device 110 may selectively fill or empty an infeed buffer based on a selected board size and slot identifier, as indicated in block 500. By providing the calibration operations, the diagnostics compute device 110 may enable determination of the effect of a given adjustment to a parameter without waiting for an entire recipe to be executed by the robotic manufacturing system 130, thereby allowing parameters to be rapidly fine tuned to achieve a desired effect (e.g., for optimal operation of a robotic component within the robotic manufacturing system 130). An embodiment of a user interface 1500 that may be produced by the diagnostics compute device 110 for performing calibration operations in accordance with the above description (e.g., relative to an infeed buffer) is shown in FIG. 15. Though the operations are shown in the method 400 in a particular order for purposes of explanation, it should be understood that the operations may be performed in a different order or concurrently, in some embodiments.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. Additional embodiments may be described in the attached appendix. There exists a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a system comprising circuitry configured to interface with a robotic manufacturing system configured to automate robotic manufacturing operations across multiple robotic manufacturing devices according to one or more recipes that define the robotic manufacturing operations in association with one or more jobs indicative of one or more building components (including but not limited to wooden structures) to be manufactured; and perform one or more diagnostic operations associated with at least one robotic manufacturing device of the robotic manufacturing system while isolating the one or more diagnostic operations from the automated robotic manufacturing operations of the robotic manufacturing system to prevent interference with production of the one or more building components.

Example 2 includes the subject matter of Example 1, and wherein to interface with a robotic manufacturing system comprises to interface with a building component manufacturing system.

Example 3 includes the subject matter of any of Examples 1 and 2, and wherein to interface with a robotic manufacturing system comprises to interface with a machine controller of a robotic manufacturing device.

Example 4 includes the subject matter of any of Examples 1-3, and wherein to interface with a machine controller of a robotic manufacturing device comprises to interface with a machine controller of a robotic assembler device, a robotic plate device, a robotic saw device, or a digital twin of the robotic manufacturing device.

Example 5 includes the subject matter of any of Examples 1-4, and wherein to interface with a robotic manufacturing system comprises to interface through a network connection.

Example 6 includes the subject matter of any of Examples 1-5, and wherein to interface through a network connection comprises to interface through an open platform communications unified architecture connection.

Example 7 includes the subject matter of any of Examples 1-6, and wherein to perform diagnostic operations comprises to perform communication monitoring operations on communication signals associated with the at least one robotic manufacturing device.

Example 8 includes the subject matter of any of Examples 1-7, and wherein to perform communication monitoring operations associated with the at least one robotic manufacturing device comprises to monitor communication signals associated with one or more sensors or one or more actuators associated with the at least one robotic manufacturing device.

Example 9 includes the subject matter of any of Examples 1-8, and wherein to perform communication monitoring operations associated with the at least one robotic manufacturing device comprises to read one or more input signals or output signals.

Example 10 includes the subject matter of any of Examples 1-9, and wherein to perform communication monitoring operations comprises to write to a numeric register or a string register of the at least one robotic manufacturing device.

Example 11 includes the subject matter of any of Examples 1-10, and wherein to perform diagnostic operations comprises to obtain a custom recipe that utilizes a subset of the robotic manufacturing devices; provide the custom recipe to the robotic manufacturing system; and monitor register values associated with the subset of the robotic manufacturing devices during execution of operations associated with the custom recipe.

Example 12 includes the subject matter of any of Examples 1-11, and wherein to provide the custom recipe to the robotic manufacturing system comprises to provide the custom recipe to machine controllers of the subset of the robotic manufacturing devices; and direct the subset of the robotic manufacturing devices to operate in a mode selected from an iterative mode to pause after each operation, an automatic mode to test a complete cycle of execution of the operations, or a repeat mode to stress test the subset of the robotic manufacturing devices.

Example 13 includes the subject matter of any of Examples 1-12, and wherein to perform diagnostic operations comprises to perform diagnostic operations pertaining to control programs for managing motions and sensors associated with a target robotic manufacturing device of the robotic manufacturing system.

Example 14 includes the subject matter of any of Examples 1-13, and wherein to perform diagnostic operations comprises to perform control program monitoring operations to track active and inactive control programs associated with a target robotic manufacturing compute device of the robotic manufacturing system, including indicating a current line of code in at least one of the control programs.

Example 15 includes the subject matter of any of Examples 1-14, and wherein to perform diagnostic operations comprises to perform condition interpretation operations to identify a paused active line of code and conditions for resumption of execution in a control program associated with a target robotic manufacturing compute device of the robotic manufacturing system.

Example 16 includes the subject matter of any of Examples 1-15, and wherein to perform diagnostic operations comprises to provide user controls to send defined data to a target robotic manufacturing device of the robotic manufacturing system.

Example 17 includes the subject matter of any of Examples 1-16, and wherein to send defined data to a target robotic manufacturing device comprises to provide simulated sensor data to the target robotic manufacturing device.

Example 18 includes the subject matter of any of Examples 1-17, and wherein to perform diagnostic operations comprises to selective start or stop execution of a control program associated with a target manufacturing compute device or selectively execute a macro program to reset register values or reposition one or more components of a target robotic manufacturing device of the robotic manufacturing system.

Example 19 includes the subject matter of any of Examples 1-18, and wherein to perform diagnostic operations comprises to provide access to a log file of a target robotic manufacturing device of the robotic manufacturing system.

Example 20 includes the subject matter of any of Examples 1-19, and wherein to perform diagnostic operations comprises to enable selective operation of a target actuator of a target robotic manufacturing device of the robotic manufacturing system.

Example 21 includes the subject matter of any of Examples 1-20, and wherein to enable selective operation of a target actuator comprises to enable selective operation as a function of whether the interlock logic to prevent interference between components of the robotic manufacturing system is satisfied.

Example 22 includes the subject matter of any of Examples 1-21, and wherein to enable selective operation of a target actuator comprises to selectively restrict allowed values for digital output associated with the target actuator as a function of at least one digital input associated with the target robotic manufacturing device.

Example 23 includes the subject matter of any of Examples 1-22, and wherein to perform diagnostic operations comprises to perform calibration operations to adjust and test the effect of parameter settings of a target robotic manufacturing device of the robotic manufacturing system.

Example 24 includes the subject matter of any of Examples 1-23, and wherein to perform calibration operations comprises to enable adjustment and testing of parameter settings separate from a job or recipe to provide feedback without disruption of a workflow.

Example 25 includes the subject matter of any of Examples 1-24, and wherein to perform calibration operations comprises to enable adjustment of parameter settings for board size, plate size, pick up locations, drop locations, or printer offsets.

Example 26 includes the subject matter of any of Examples 1-25, and wherein to perform calibration operations comprises to selectively fill or empty an infeed buffer based on a selected board size and slot identifier.

Example 27 includes a method comprising interfacing, by a compute device, with a robotic manufacturing system configured to automate robotic manufacturing operations across multiple robotic manufacturing devices according to one or more recipes that define the robotic manufacturing operations in association with one or more jobs indicative of one or more building components (including but not limited to wooden structures such as floor trusses and roof trusses) to be manufactured; and performing, by the compute device, one or more diagnostic operations associated with at least one robotic manufacturing device of the robotic manufacturing system while isolating the one or more diagnostic operations from the automated robotic manufacturing operations of the robotic manufacturing system to prevent interference with production of the one or more building components.

Example 28 includes the subject matter of Example 27, and wherein interfacing with a robotic manufacturing system comprises interfacing with a building component manufacturing system.

Example 29 includes the subject matter of any of Examples 27 and 28, and wherein interfacing with a robotic manufacturing system comprises interfacing with a machine controller of a robotic manufacturing device.

Example 30 includes the subject matter of any of Examples 27-29, and wherein interfacing with a machine controller of a robotic manufacturing device comprises interfacing with a machine controller of a robotic assembler device, a robotic plate device, a robotic saw device, or a digital twin of the robotic manufacturing device.

Example 31 includes the subject matter of any of Examples 27-30, and wherein interfacing with a robotic manufacturing system comprises interfacing through a network connection.

Example 32 includes the subject matter of any of Examples 27-31, and wherein interfacing through a network connection comprises interfacing through an open platform communications unified architecture connection.

Example 33 includes the subject matter of any of Examples 27-32, and wherein performing diagnostic operations comprises performing communication monitoring operations on communication signals associated with the at least one robotic manufacturing device.

Example 34 includes the subject matter of any of Examples 27-33, and wherein performing communication monitoring operations associated with the at least one robotic manufacturing device comprises monitoring communication signals associated with one or more sensors or one or more actuators associated with the at least one robotic manufacturing device.

Example 35 includes the subject matter of any of Examples 27-34, and wherein performing communication monitoring operations associated with the at least one robotic manufacturing device comprises reading one or more input signals or output signals.

Example 36 includes the subject matter of any of Examples 27-35, and wherein performing communication monitoring operations comprises writing to a numeric register or a string register of the at least one robotic manufacturing device.

Example 37 includes the subject matter of any of Examples 27-36, and wherein performing diagnostic operations comprises obtaining a custom recipe that utilizes a subset of the robotic manufacturing devices; providing the custom recipe to the robotic manufacturing system; and monitoring register values associated with the subset of the robotic manufacturing devices during execution of operations associated with the custom recipe.

Example 38 includes the subject matter of any of Examples 27-37, and wherein providing the custom recipe to the robotic manufacturing system comprises providing the custom recipe to machine controllers of the subset of the robotic manufacturing devices; and directing the subset of the robotic manufacturing devices to operate in a mode selected from an iterative mode to pause after each operation, an automatic mode to test a complete cycle of execution of the operations, or a repeat mode to stress test the subset of the robotic manufacturing devices.

Example 39 includes the subject matter of any of Examples 27-38, and wherein performing diagnostic operations comprises performing diagnostic operations pertaining to control programs for managing motions and sensors associated with a target robotic manufacturing device of the robotic manufacturing system.

Example 40 includes the subject matter of any of Examples 27-39, and wherein performing diagnostic operations comprises performing control program monitoring operations to track active and inactive control programs associated with a target robotic manufacturing compute device of the robotic manufacturing system, including indicating a current line of code in at least one of the control programs.

Example 41 includes the subject matter of any of Examples 27-40, and wherein performing diagnostic operations comprises performing condition interpretation operations to identify a paused active line of code and conditions for resumption of execution in a control program associated with a target robotic manufacturing compute device of the robotic manufacturing system.

Example 42 includes the subject matter of any of Examples 27-41, and wherein performing diagnostic operations comprises providing user controls to send defined data to a target robotic manufacturing device of the robotic manufacturing system.

Example 43 includes the subject matter of any of Examples 27-42, and wherein sending defined data to a target robotic manufacturing device comprises providing simulated sensor data to the target robotic manufacturing device.

Example 44 includes the subject matter of any of Examples 27-43, and wherein performing diagnostic operations comprises selectively starting or stopping execution of a control program associated with a target manufacturing compute device or selectively executing a macro program to reset register values or reposition one or more components of a target robotic manufacturing device of the robotic manufacturing system.

Example 45 includes the subject matter of any of Examples 27-44, and wherein performing diagnostic operations comprises providing access to a log file of a target robotic manufacturing device of the robotic manufacturing system.

Example 46 includes the subject matter of any of Examples 27-45, and wherein performing diagnostic operations comprises enabling selective operation of a target actuator of a target robotic manufacturing device of the robotic manufacturing system.

Example 47 includes the subject matter of any of Examples 27-46, and wherein enabling selective operation of a target actuator comprises enabling selective operation as a function of whether interlock logic to prevent interference between components of the robotic manufacturing system is satisfied.

Example 48 includes the subject matter of any of Examples 27-47, and wherein enabling selective operation of a target actuator comprises selectively restricting allowed values for digital output associated with the target actuator as a function of at least one digital input associated with the target robotic manufacturing device.

Example 49 includes the subject matter of any of Examples 27-48, and wherein performing diagnostic operations comprises performing calibration operations to adjust and test the effect of parameter settings of a target robotic manufacturing device of the robotic manufacturing system.

Example 50 includes the subject matter of any of Examples 27-49, and wherein performing calibration operations comprises enabling adjustment and testing of parameter settings separate from a job or recipe to provide feedback without disruption of a workflow.

Example 51 includes the subject matter of any of Examples 27-50, and wherein performing calibration operations comprises enabling adjustment of parameter settings for board size, plate size, pick up locations, drop locations, or printer offsets.

Example 52 includes the subject matter of any of Examples 27-51, and wherein performing calibration operations comprises selectively filling or emptying an infeed buffer based on a selected board size and slot identifier.

Example 53 includes one or more machine-readable storage media comprising a plurality of instructions stored thereon that, in response to being executed, cause a diagnostics compute device to perform the method of any of Examples 27-52.

1. A system comprising:
circuitry configured to:
interface with a robotic manufacturing system configured to automate robotic manufacturing operations across multiple robotic manufacturing devices according to one or more recipes that define the robotic manufacturing operations in association with one or more jobs indicative of one or more building components to be manufactured; and
perform one or more diagnostic operations associated with at least one robotic manufacturing device of the robotic manufacturing system while isolating the one or more diagnostic operations from the automated robotic manufacturing operations of the robotic manufacturing system to prevent interference with production of the one or more building components.

2. The system of claim 1, wherein to interface with a robotic manufacturing system comprises to interface with a building component manufacturing system.

3. The system of claim 1, wherein to interface with a robotic manufacturing system comprises to interface with a machine controller of a robotic manufacturing device.

4. The system of claim 3, wherein to interface with a machine controller of a robotic manufacturing device comprises to interface with a machine controller of a robotic assembler device, a robotic plate device, a robotic saw device, or a digital twin of the robotic manufacturing device.

5. . The system of claim 1, wherein to perform diagnostic operations comprises to:
obtain a custom recipe that utilizes a subset of the robotic manufacturing devices;
provide the custom recipe to the robotic manufacturing system; and
monitor register values associated with the subset of the robotic manufacturing devices during execution of operations associated with the custom recipe.

6. The system of claim 5, wherein to provide the custom recipe to the robotic manufacturing system comprises to:
provide the custom recipe to machine controllers of the subset of the robotic manufacturing devices; and
direct the subset of the robotic manufacturing devices to operate in a mode selected from an iterative mode to pause after each operation, an automatic mode to test a complete cycle of execution of the operations, or a repeat mode to stress test the subset of the robotic manufacturing devices.

7. The system of claim 1, wherein to perform diagnostic operations comprises to perform communication monitoring operations on communication signals associated with the at least one robotic manufacturing device, including monitoring communication signals associated with one or more sensors or one or more actuators associated with the at least one robotic manufacturing device.

8. The system of claim 8, wherein to perform communication monitoring operations associated with the at least one robotic manufacturing device comprises to read one or more input signals or output signals or write to a numeric register or a string register of the at least one robotic manufacturing device.

9. The system of claim 1, wherein to perform diagnostic operations comprises to perform diagnostic operations pertaining to control programs for managing motions and sensors associated with a target robotic manufacturing device of the robotic manufacturing system, including tracking active and inactive control programs associated with a target robotic manufacturing compute device of the robotic manufacturing system and indicating a current line of code in at least one of the control programs.

10. The system of claim 1, wherein to perform diagnostic operations comprises to perform condition interpretation operations to identify a paused active line of code and conditions for resumption of execution in a control program associated with a target robotic manufacturing compute device of the robotic manufacturing system.

11. The system of claim 1, wherein to perform diagnostic operations comprises to provide user controls to send defined data to a target robotic manufacturing device of the robotic manufacturing system.

12. The system of claim 11, wherein to send defined data to a target robotic manufacturing device comprises to provide simulated sensor data to the target robotic manufacturing device.

13. The system of claim 1, wherein to perform diagnostic operations comprises to selectively start or stop execution of a control program associated with a target manufacturing compute device or selectively execute a macro program to reset register values or reposition one or more components of a target robotic manufacturing device of the robotic manufacturing system.

14. The system of claim 1, wherein to perform diagnostic operations comprises to provide access to a log file of a target robotic manufacturing device of the robotic manufacturing system.

15. The system of claim 1, wherein to perform diagnostic operations comprises to enable selective operation of a target actuator of a target robotic manufacturing device of the robotic manufacturing system as a function of whether interlock logic to prevent interference between components of the robotic manufacturing system is satisfied or selectively restrict allowed values for digital output associated with the target actuator as a function of at least one digital input associated with the target robotic manufacturing device.

16. The system of claim 1, wherein to perform diagnostic operations comprises to perform calibration operations to adjust and test the effect of parameter settings of a target robotic manufacturing device of the robotic manufacturing system, including enabling adjustment and testing of parameter settings separate from a job or recipe to provide feedback without disruption of a workflow.

17. The system of claim 16, wherein to perform calibration operations comprises to enable adjustment of parameter settings for board size, plate size, pick up locations, drop locations, and printer offsets.

18. The system of claim 16, wherein to perform calibration operations comprises to selectively fill or empty an infeed buffer based on a selected board size and slot identifier.

19. A method comprising:
interfacing, by a compute device, with a robotic manufacturing system configured to automate robotic manufacturing operations across multiple robotic manufacturing devices according to one or more recipes that define the robotic manufacturing operations in association with one or more jobs indicative of one or more building components to be manufactured; and
performing, by the compute device, one or more diagnostic operations associated with at least one robotic manufacturing device of the robotic manufacturing system while isolating the one or more diagnostic operations from the automated robotic manufacturing operations of the robotic manufacturing system to prevent interference with production of the one or more building components.

20. One or more machine-readable storage media comprising a plurality of instructions stored thereon that, in response to being executed, cause a diagnostics compute device to:
interface with a robotic manufacturing system configured to automate robotic manufacturing operations across multiple robotic manufacturing devices according to one or more recipes that define the robotic manufacturing operations in association with one or more jobs indicative of one or more building components to be manufactured; and
perform one or more diagnostic operations associated with at least one robotic manufacturing device of the robotic manufacturing system while isolating the one or more diagnostic operations from the automated robotic manufacturing operations of the robotic manufacturing system to prevent interference with production of the one or more building components.
